(19) United States
(12) Patent Application Publication
(10) Pub. No.: US 2009/0026260 A1
(43) Pub. Date: Jan. 29, 2009

(54) System and method for the secure input of a PIN

(76) Inventors: Horst Dressel, Velden (DE); Thomas Zapf, Pegnitz (DE); Manfred Dorn, Nurnberg (DE); Hans Pickelmann, Neukirchen (DE)

Correspondence Address: Raymond R. Ferrera, 1221 McKinney Street, Suite 4400, Houston, TX, 77010, US

(21) Appl. No.: 12/220,471

(22) Filed: Jul. 24, 2008

(30) Foreign Application Priority Data
Jul. 24, 2007 (DE) 10 2007 034 346.0

(51) Int. Cl. G06F 19/00

(52) U.S. Cl. 235/380

(57) ABSTRACT

The invention relates to a system and a method for the secure input of a PIN on a chip card reader, without its own display, which is connected to a computer system. After an application requests the input of a PIN, the chip card reader passes information to a PIN input program on the computer system, and this program guides the user through the PIN entry procedure.

### STATEMENT OF RELATED CASES

Pursuant to 35 U.S.C. 119(a), the instant application claims priority to prior German application number 10 2007 034 346.0, filed Jul. 24, 2007.

### BACKGROUND OF THE INVENTION

The invention relates to a system and a method for the secure entering of a code, in particular of a personal identification number (PIN), on a computer system.

A personal identification number (PIN), or secret number, is a number that is known to only one person, or only a few persons, with which one can authenticate oneself to a machine.

A common use for PINs is the authentication at an automatic teller machine. In this case, input of a four-figure number is required in order to prevent access to an account by non-authorized persons. It is also possible in many stores and businesses to make payments using the bank card, together with its PIN, instead of cash.

A PIN is also normally necessary for internet banking. Using the PIN and the account details, one can view one's account, the balance, and the latest transactions. Using a transaction number (TAN), one can transfer money or make other banking transactions.

For authentication of internet banking, it is also possible to use the newer Home Banking Computer Interface (HBCI). For this, the user requires an HBCI chip card and a chip card reader, which is connected to the computer from which the user will do the internet banking.

Because the PIN is input directly into the chip card reader, rather than by the computer keyboard, this method prevents both reading out of the encryption key from the card and capturing of the entry of the PIN by use of a keylogger or trojan. The method also rules out phishing, since in order to complete a transaction one must be in possession of the electronic signature, i.e. in possession of the chip card.

User authentication by means of a chip card and its associated PIN is also used in other areas. One example is the electronic submission of tax returns using the ELSTER system, in which it is possible to authenticate the user by means of a chip card.

Chip card readers which can be connected to a computer are divided into four security classes, depending on the security features that they possess. The specification of the Association of German Banks (Zentraler Kreditausschuss, ZKA) describes the following four security levels:

Security Class 1: devices in this class have no special security features. The card reader functions only as a contact unit for the chip card.

Security Class 2: this chip card reader comprises a keypad, using which, for example, the home banking PIN can be directly entered. This prevents in practice the electronic theft of the PIN (e.g. by means of a keylogger or trojan).

Security Class 3: in addition to a keypad, these devices also possess a display, and enable the subsequent installation of additional applications.

Security Class 4: these devices also possess a security module with RSA encryption.

The applications mentioned above generally use Security Class 2 chip card readers, which do not have their own displays and thus rely on the computer monitor for communication with the user. The basic methods for secure input of a PIN are as follows:

The first method is to use the VERIFY_PIN_DIRECT function for data input by the PC/SC (personal computer smartcard) interface. When this function is called, the input and verification of the PIN on the chip card reader or the chip card itself takes place without any communication between the chip card reader and the computer.

The application which called the VERIFY_PIN_DIRECT function does not receive a response until the input and verification process is completed. Furthermore, the user is not guided through the process by a dialogue on the computer monitor.

The second method for input by the PC/SC interface is by means of the VERIFY_PIN_START and VERIFY_PIN_FINISH functions. These functions are used when running an application which itself needs to display a dialogue requesting input of a PIN, or when an application requires a response reporting the keys pressed. The application which calls these functions can thereby receive a response informing it, for example, whether the required number of numeric characters have already been entered by the keypad on the chip card reader.

However, this latter method is more difficult to implement than that which uses the VERIFY_PIN_DIRECT function. The application developer must program his or her own dialogue for PIN input, and as a consequence these dialogues vary between different applications, meaning that the user must first accustom himself or herself to the new dialogues. The user may well become suspicious, particularly in the light of increasing attempts at internet banking frauds, when, for instance, he or she is presented with a different PIN input dialogue after installing a program update.

As an alternative to the PC/SC interface, the PIN can be input by a secure PIN entry service provider which the manufacturer of the chip card makes available. In this case, the service provider displays a dialogue on the computer monitor which is independent of the application requiring input of a PIN.

However, in this method the service provider is specific to an individual manufacturer, and the application developer must thus take care that the application supports all service providers of all manufacturers of chip card readers.

The object of the present invention is therefore to provide a possibility of securely inputting a PIN which avoids the above-mentioned disadvantages of the prior art.

This problem is solved by a system and a method for secure input of a PIN according to the present invention.

### DESCRIPTION OF THE INVENTION

A system for secure input of a PIN according to the present invention comprises a card reading device and a PIN input program which runs on a computer system. The card reading device can be a chip card reader with a numerical keypad but without a display, in accordance with Security Class 2 above. But it is also possible to use card reading devices with integrated displays (i.e. Security Class 3 card reading devices), in which case the communication with the user takes place not by the card reading device's display, but by the monitor of a computer system to which the card reading device is connected.

Communication with the user is controlled by the PIN input program, which can be run on the computer system to which the card reading device is connected. The PIN input program can, for instance, notify the user how many numeric characters of the PIN he or she has already entered, in order that the user knows whether his or her previous inputs have been recognized and which digit is required next.

The card reading device in accordance with the system for secure input of a PIN according to the present invention comprises a means of passing information to the PIN input program on the computer system. The information is thereby not passed directly to the PIN input program by an application which runs on the computer system, but by the intermediary of the card reading device, when the application which requires input of a PIN requests the card reading device to do this.

In the context of the present invention, “passing information” to a program or a device is to be understood to mean transferring data to the program or device. If the program that is to receive the information is not running, the term “passing information” also comprises starting the program. An example of passing information in the sense used by the present invention is the initialization of a program by means of the transfer of the appropriate commands and the transfer of user data, such as which key is pressed.

The application can thus limit itself to requesting a PIN input from the card reading device by the use of a conventional method, such as the easy-to-implement VERIFY_PIN_DIRECT function mentioned above. It is not, for instance, necessary to adapt the application to a manufacturer-specific service provider.

Despite this, and in contrast to the conventional method which operates by calling the VERIFY_PIN_DIRECT function, the user receives a response from the PIN input program, and can be guided through the PIN input method by means of this.

A further advantage of the present invention is that a user who connects a card reading device according to the present invention to a computer system does not need to install drivers specific to a particular manufacturer or to a device on the computer system—a method which normally requires administrator rights on the computer system. On the contrary, the PIN input program according to the present invention is a normal application, which can be so configured as to require only limited user rights, rather than administrator rights, for installation on a computer system.

If the PIN input program is written in a programming language (such as JAVA), which is independent of an operating system, the system for secure input of a PIN according to the present invention can also be used in different operating systems without the necessity for drivers specific to particular operating systems.

In addition, system stability is not adversely affected by manufacturer-specific drivers which run on the computer system in kernel mode. On the contrary, the PIN input program according to the present invention runs as a normal application in user mode.

In a preferred embodiment of the system according to the present invention, the card reading device comprises a CCID device, and the means of passing information to the PIN input program comprises an HID device.

A CCID device (chip card interface device) is thereby a (physical and/or logical) unit in the card reading device, which can communicate with the computer system by means of a CCID driver that is installed on the computer system. The CCID device class includes card reading devices from the various Security Classes listed above. CCID drivers are provided by all modern operating systems (such as Linux and Microsoft Windows). No additional driver installation is therefore necessary.

An HID device (human interface device) is a (physical and/or logical) unit in the card reading device, which can communicate with the computer system by means of an HID driver that is already available on the computer system. HID devices belong to a class of devices, such as keyboards and computer mice, which can interact directly with the user. HID drivers are provided by all modern operating systems (such as Linux and Microsoft Windows). No additional driver installation is therefore necessary.

In place of the CCID and HID drivers, drivers for other device classes can also be used in a system according to the present invention in order to support manufacturer-specific data transfer.

In a further preferred embodiment of the system according to the present invention, the card reading device also comprises means of passing information to the HID device by the CCID device.

In a further preferred embodiment of the system according to the present invention, the card reading device comprises several keys, by means of which the user can enter the PIN on the card reading device.

In a further preferred embodiment of the system according to the present invention, the card reading device comprises a computer keyboard. For example, a card reading device and a computer keyboard are combined in a single case. As long as no PIN input is required, the card reading part of this card reading device with a computer keyboard can remain deactivated, and the keyboard part functions in the same way as a normal computer keyboard without a card reading part. Only when a user application requires the input of a PIN is the card reader part activated.

In an especially preferred embodiment of the system according to the present invention, during the input of the PIN at least the alphanumeric section of the keyboard part of the card reading device with a computer keyboard can be deactivated. It is especially preferable that other keys on the keyboard part, such as the function keys or the cursor keys, can be deactivated. The numeric keypad, which is not deactivated, then communicates only with the card-reading part, in order to enable input of the PIN. When entry of the PIN is complete, the alphanumeric keys are reactivated, and the keyboard part can continue to be used normally.

In a further preferred embodiment of the system according to the present invention, the card reading device comprises a means of communicating the keys pressed on the card reading device to the PIN input program on the computer system. The means of communicating the keys pressed on the card reading device can thereby either communicate which key was pressed, or only the fact that a key was pressed. For example, when a number key is pressed, the information that a number key was pressed can be communicated, but not which key. On the other hand, when an “Enter” or “Cancel” key is pressed, the identity of that key can also be communicated.

The method normally begins the verification of the PIN after the user has pressed the “Enter” key. Alternatively, the verification can start without operation of an “Enter” key, for instance after a timeout or when the user has entered the maximum number of numeric characters required for the PIN.

In a further preferred embodiment of the system according to the present invention, the card reading device comprises a means of communicating the numeric characters entered for the PIN to the chip card. To achieve this, for example, the numeric characters of the PIN that are entered are inserted into a command, which is passed to the chip card inserted into the card reading device in order to compare these numeric characters with the PIN which is stored securely (e.g. encrypted) on the chip card.

In a further preferred embodiment of the system according to the present invention, the card reading device comprises a means of communicating a result of the PIN comparison to the PIN input program on the computer system.

When the result of verification of the entered PIN is that the correct PIN was input, this result can be communicated to the PIN input program, and the user can receive confirmation from the PIN input program that he or she entered the correct PIN.

When the result of verification of the entered PIN is that the incorrect PIN was input, this result can be communicated to the PIN input program, and the PIN input program can request the user to re-enter the PIN.

In a further preferred embodiment of the system according to the present invention, the card reading device comprises a means of communicating a result of the PIN comparison to a user application on the computer system.

When the result of verification of the entered PIN is that the correct PIN was input, this result can be communicated to the user application which required entry of the PIN, and this application can proceed with its programmed response to this information.

When the result of verification of the entered PIN is that the incorrect PIN was input, this result can be communicated to the user application which required entry of the PIN, and this user application can proceed with its programmed response to this information, for instance by waiting for re-entry of the PIN.

This means of communicating a result of a PIN comparison to a user application on the computer system can be the CCID device itself, or a different means.

The present invention relates to a method for secure input of a PIN, which comprises the following steps:

A user application which is running on a computer system requires the authentication of the user in order to proceed. For this purpose, the user application first requests the input of a PIN from a card reading device.

The card reading device from which the PIN input is requested then informs the PIN input program on the computer system on which the user application which requested the PIN input is running. This PIN input program serves to guide the user through the PIN input method by means of screen prompts. Because of this, a card reading device without its own display (i.e. a Security Class 2 card reading device) can be used to input the PIN. But it is also possible to use a card reading device with an integrated display (i.e. a Security Class 3 card reading device), in which case the communication with the user will not take place by the card reading device's display, but by the monitor of the computer system to which the card reading device is connected.

The PIN input program then displays an input dialogue on the monitor of the computer system, in order to guide the user through the PIN input method.

The numeric characters entered by the user are then verified by the chip card, through a comparison of the entered numeric characters with the PIN which is stored securely (e.g. encrypted) on the chip card inserted into the card reading device. To achieve this, the numeric characters of the PIN that are entered are, for example, inserted into a command which is passed to the chip card.

The PIN input program which guides the user through the PIN input method, and the user application which requires the PIN input, are programs which are independent of each other. In particular, there is no direct communication between the PIN input program and the user application. Instead, both the PIN input program and the user application communicate with the card reading device.

In a preferred embodiment of the method according to the present invention, the request for PIN input from the card reading device takes place by calling the easy-to-implement function “VERIFY_PIN_DIRECT” either by the user application itself, or by a program launched by the user application. It is thus not necessary that the user program is adapted, for example, to a manufacturer-specific service provider.

In contrast to the conventional method which operates by calling the VERIFY_PIN_DIRECT function, the user of the method according to the present invention receives a response from the PIN input program, and can be guided through the PIN input method by means of this.

In a further preferred embodiment of the method according to the present invention, the method further comprises the step of passing information to an HID device in the card reading device by a CCID device in the card reading device.

In a further preferred embodiment of the method according to the present invention, the information is passed to the PIN input program on the computer system by means of the HID device in the card reading device.

In a further preferred embodiment of the method according to the present invention, the method further comprises the step of communicating the keys pressed on the card reading device to the PIN input program on the computer system. The information communicated can be either which key was pressed, or only the fact that a key was pressed. For example, when a number key is pressed, the information that a number key was pressed can be communicated, but not which key. On the other hand, when an “Enter” or “Cancel” key is pressed, the identity of that key can also be communicated.

The method for verification of the PIN normally begins after the user has pressed the “Enter” key. Alternatively, the verification can start without operation of an “Enter” key, for instance after a timeout or when the user has entered the maximum number of numeric characters required for the PIN.

In a further preferred embodiment of the method according to the present invention, the method further comprises the step of communicating by the card reading device of the result of the PIN comparison, which takes place on the chip card, to the PIN input program on the computer system.

In a further preferred embodiment of the method according to the present invention, the communication of the result of the PIN comparison to the PIN input program on the computer system takes place by the HID device on the card reading device.

When the result of verification of the entered PIN is that the correct PIN was input, this result can be communicated to the PIN input program, and the user can receive confirmation from the PIN input program that he or she entered the correct PIN.

When the result of verification of the entered PIN is that the incorrect PIN was input, this result can be communicated to the PIN input program, and the PIN input program can request the user to re-enter the PIN.

In a further preferred embodiment of the method according to the present invention, the method further comprises the step of communication by the card reading device of the result of the PIN comparison, which takes place on the chip card, to the user application on the computer system.

When the result of verification of the entered PIN is that the correct PIN was input, this result can be communicated to the user application which required entry of the PIN, and this user application can proceed with its programmed response to this information.

When the result of verification of the entered PIN is that the incorrect PIN was input, this result can be communicated to the user application which required entry of the PIN, and this user application can proceed with its programmed response to this information, for instance by waiting for re-entry of the PIN

In a further preferred embodiment of the method according to the present invention, the communication to the user application on the computer system of the result of the verification of the PIN which was input takes place by the CCID device on the card reading device.

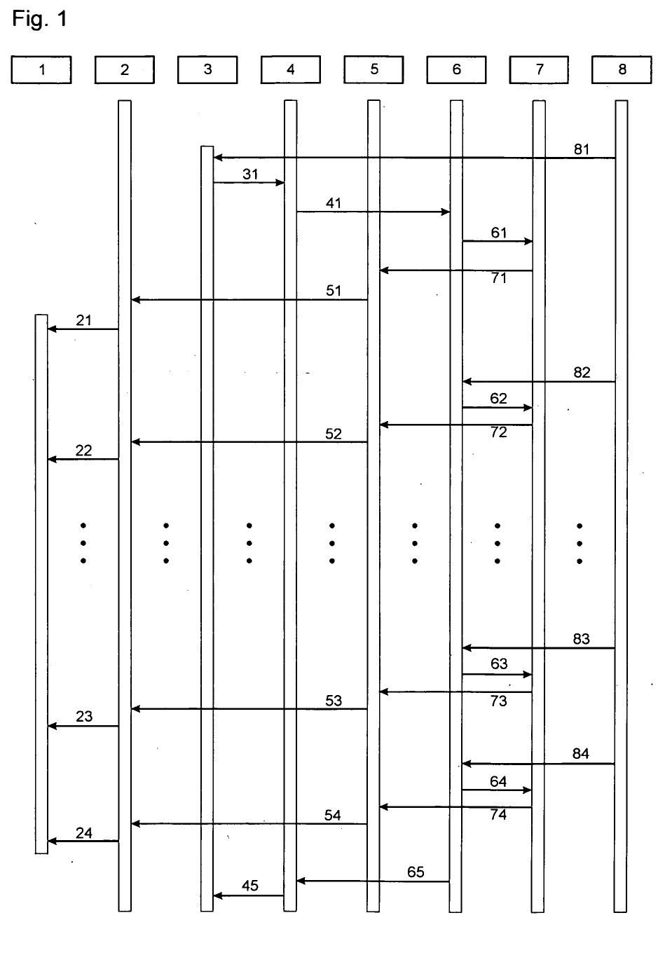

The invention is described in detail below with the aid of the diagram. FIG. 1 shows a schematic representation of the functioning of a preferred embodiment of the method according to the present invention.

The schematic functioning of a preferred embodiment of the method according to the present invention is apparent from the representation in FIG. 1. The elements which are involved in the method are represented by the rectangles at the top of FIG. 1. These rectangles represent:
1 the graphical user interface (GUI) of the PIN input program (front-end);
2 the part of the PIN input program which does not belong to the graphical user interface (back-end);
3 the user application;
4 the CCID driver;
5 the HID driver;
6 the CCID device;
7 the HID device; and
8 the user.

Thus elements (1) to (5) are programs, or components of programs, which run on a computer system. While elements (1) to (3) run in user mode, elements (4) and (5)—the two drivers, which are normally supplied by the operating system—run in kernel mode.

Elements (6) and (7)—the two devices—are logical components of a card reading device which is connected to the computer system, for example by a USB port.

Element (8) represents the user of the computer system and the card reading device.

Elements (1) and (2)—back-end and front-end of the PIN input program—thus represent a virtual display for the card reading device.

The elongated bars arranged below the rectangles (1) to (8) represent the duration of the activity of the corresponding elements. From this it is clear that the back-end of the PIN input program and the two drivers run at least as long as a card reading device is connected with the computer system, while the user application (3) does not run until it is launched by the user (8).

At step (81), the user (8) launches a user application (3) on the computer system, for example by the operating system's graphical user interface or by a command line. The user application (3) can be, for example, an internet banking program. To be able to log into the bank's server, the user must insert his or her compatible chip card into the card reading device and authenticate himself or herself by the input of the corresponding PIN.

For this purpose, at step (31) the user application (3) requests input of the PIN by means of the function VERIFY_PIN_DIRECT by the CCID driver (4) which is running on the computer system.

The CCID driver (4) passes the VERIFY_PIN_DIRECT function to the CCID device (6) on the card reading device. The card reading device is now ready to receive the entry of the numeric characters by the user (8). However, this is not visible to the user (8) if the card reading device does not have its own display.

In order to inform the user (8) that he or she can now enter the numeric characters of the PIN, at step (61) the CCID device (6) on the card reading device informs an HID device (7) on the card reading device that secure PIN input is now commencing.

The HID device (7) on the card reading device passes the Open Dialog information to the HID driver (5) on the computer system at step (71), and the HID driver (5) passes this information on at step (51) to the back-end (2) of the PIN input program. At step (21), the back-end (2) opens the front-end (1) (i.e. the graphical user interface) of the PIN input program.

By this means the user (8) can be shown on the computer system's monitor that the card reading device is ready to receive input from the user (8).

The numeric characters that are received by the card reading device are inserted into a command and passed to the chip card, in order to compare these numeric characters on the chip card with the PIN which is stored securely there.

At step (82), the user (8) enters the first digit of the PIN. This input is received by the CCID device (6). At step (62), the CCID device (6) notifies the HID device (7) of the pressed key. The HID device (7) passes this information on to the HID driver (5) at step (72).

At step (52), the HID driver (5) passes the information about the pressed key to the back-end (2) of the PIN input program, which generates an appropriate output by the GUI (1) at step (22). This output can, for example, consist of the display of one asterisk (*) on the computer system's monitor to represent each pressed key.

The entry of further numeric characters of the PIN follows a similar method to the entry of the first digit, until the entry of the last digit at step (83) is processed by steps (63), (73), (53), and (23) in the method, which are similar to steps (62), (72), (52), und (22).

At step (84), the user (8) presses the “Enter” key to finish the PIN input. This input is received, like the input of the numeric characters, by the CCID device (6). At step (64), the CCID device (6) passes the information about the pressing of the “Enter” key to the HID device (7), which passes this information on to the HID driver (5) at step (74).

At step (54), the HID driver (5) passes the information about the pressing of the “Enter” key to the back-end (2) of the PIN input program, which closes the GUI (1) of the PIN input program at step (24).

After the “Enter” key is pressed, the chip card verifies the PIN that was input. The CCID device (6) now, at step (64), passes the information to the HID device (7).

At step (74), the HID device (7) informs the HID driver (5) that the PIN entry is complete. The HID driver (5) then informs the back-end (2) of the PIN input program at step (54) about the completion of the PIN entry.

The CCID device (6) now, at step (65), informs the CCID driver (4), which informs the user application (3), at step (45), that the PIN entry is complete.

The sequence of steps (64, 74, 54, 24) and the sequence (65, 45) can be performed simultaneously or in any order.

Pressing another function key than the “Enter” key, for example the “Cancel” key, does not alter the method according to the present invention.

If the “Back” function key is pressed, the output of the key that was last pressed is cleared in the front-end (2), and/or the last pressed number in the memory of the CCID device is deleted.

After step (45), the user program (3) continues according to the result of the verification of the PIN input, for example allowing a user (8) who has entered the correct PIN access to his or her bank account by the internet, or denying access to a user who has entered the wrong PIN.

An advantage of this method is that no loop in a program starts recurrent checks as to whether a key on the card reading device has been depressed (polling). Instead, a command to update the graphical user interface is only executed upon the pressing of a key.

### LIST OF REFERENCE SYMBOLS

1 graphical user interface of the PIN input program (front-end)
2 the part of the PIN input program which does not belong to the graphical user interface (back-end)
3 user application
4 CCID driver
5 HID driver
6 CCID device
7 HID device
8 user

1. A system for secure input of a PIN, comprising a card reading device and a PIN input program for execution on a computer system, characterized in that the card reading device comprises a CCID device and a means for passing information to the PIN input program on the computer system, wherein the means for passing information to the PIN input program on the computer system comprises an HID device, and in that the card reading device comprises a means for passing information to the HID device by the CCID device.

2. A system according to claim 1 wherein the card reading device comprises several keys.

3. A system according to claim 1 wherein the card reading device comprises a computer keyboard.

4. A system according to claim 3, wherein at least the alphanumeric keypad on the computer keyboard is deactivatable, and wherein the card reading device comprises a means for communicating with a numeric keypad of the computer keyboard.

5. A system according to claim 2, wherein the card reading device comprises a means for communicating the keys pressed on the card reading device to the PIN input program on the computer system.

6. A system according to claim 2, wherein the card reading device comprises a means for communicating the keys pressed on the card reading device to a chip card inserted into the card reading device.

7. A system according to claim 1 wherein the card reading device comprises a means for communicating a result of a verification of the entered PIN on a chip card which is inserted into the card reading device to the PIN input program on the computer system by the card reading device.

8. A system according to claim 1 wherein the card reading device comprises a means for communicating a result of a verification of the entered PIN on a chip card which is inserted into the card reading device to a user application on the computer system by the card reading device.

9. A method for secure input of a PIN comprising the steps:
requesting the input of a PIN from a card reading device by a user application running on a computer system;
passing information to an HID device of the card reading device by an CCID device of the card reading device;
passing information to a PIN input program of the computer system by the HID device of the card reading device;
displaying an input dialogue by the PIN input program; and
verifying the entered numeric characters of the PIN by a chip card which is inserted into the card reading device.

10. A method according to claim 9, wherein the requesting of the PIN input from the card reading device is effected by calling of the “VERIFY_PIN_DIRECT” function.

11. A method according to claim 9, wherein the method further comprises the step of communicating the keys pressed on the card reading device to the PIN input program on the computer system.

12. A method according to claim 9, wherein the method further comprises the step of communicating the result of the verification of the entered numeric characters of the PIN on a chip card which is inserted into the card reading device to the PIN input program on the computer system by the card reading device.

13. A method according to claim 12, wherein the communication of the result of the verification of the entered numeric characters of the PIN to the PIN input program on the computer system is effected by the HID device on the card reading device.

14. A method according to claim 9, wherein the method further comprises the additional step of communicating the result of the verification of the entered numeric characters of the PIN on a chip card which is inserted into the card reading device to the user application on the computer system by the card reading device.

15. A method according to claim 14, wherein the communication of the result of the verification of the entered numeric characters of the PIN to the user application on the computer system is effected by the CCID device of the card reading device.
